(19) United States
(12) Patent Application Publication
(10) Pub. No.: US 2007/0233577 A1
(43) Pub. Date: Oct. 4, 2007

(54) Lead distribution method and system

(76) Inventor: Arthur J. Glass, Staten Island, NY (US)

Correspondence Address: WHITE-WELKER & WELKER, LLC, P.O. BOX 199, CLEAR SPRING, MD, 21722-0199, US

(21) Appl. No.: 11/396,862

(22) Filed: Apr. 3, 2006

(51) Int. Cl. G06Q 30/00

(52) U.S. Cl. 705/26

(57) ABSTRACT

A method is disclosed for generating and distributing a sales referral over the Internet for the sale of an asset. A consumer who engages a website and then enters information relating to the asset they wish to acquire. The consumer's information is then transferred to a central computer, which then conducts a search of each member's inventory stored on the central computer for the asset. When the asset is located, the central computer generates an electronic communication that is then sent to the customer including such information as availability and cost.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to an Internet-implemented system for providing leads to salespeople and companies with large inventories. More specifically the present invention relates to enabling a third party consumer to search a central computer that stores a plurality of inventory databases of members, and upon the matching of any search query to an inventory item, automatically generates an electronic communication that appears to come directly from the member.

### BACKGROUND OF THE INVENTION

The Internet has become the fastest new medium to reach 60% of U.S. households in recorded history, much faster than the penetration of telephone, radio, television, or cable TV. In addition, time spent on the Internet is currently the fastest-growing segment of media usage. As the Internet continues to grow in accessibility and breadth, it is becoming an increasingly important tool for business. Accordingly, the widespread availability of the Internet has made it a valuable resource for salespeople and for prospective customers alike.

Several methods of using the Internet to sell assets have arisen. In one method, a salesperson, herein defined as any type of sales entity, such as for example one or more individuals, or a legal entity such as a corporation, may use a web site for advertising assets for sale.

In another method, the salesperson may also advertise assets or may provide selection criteria (such as a search term or other means of selecting assets to view, or an asset listing itself) for an asset that another salesperson is selling. When a consumer selects such an asset or criterion in a web page, the salesperson actually selling the asset receives a sales lead, and in return a referral fee is generated for the salesperson whose web site generated the lead.

Typically, referral fees are created when the lead is generated, when the sale is completed, or in any other manner agreed to by the salespeople. In this way, a salesperson may reach a broader consumer audience for the sale of an asset, at the cost of providing a referral fee.

A problem with this method is that a web site operated by an individual salesperson, or even several web sites operated by one or more salespeople, will most likely have a low number of consumer visits because such salespeople lack the advertising budget or ability to gain widespread awareness of their web sites.

Most consumers, however, visit a well-known major web site to search for an asset the consumer wishes to purchase. Such a major web site enjoys a large number of visitors, and advertises assets for sale either as a primary or secondary purpose. Thus, a major web site may have a large number of visitors to its sales advertising area, but the primary purpose of the web site, and the primary reason the web site is well know, may be for another purpose unrelated to such sales. Such a major web site may list many or all of the assets in the class of assets the consumer desires.

In one situation, the major web site owns the asset and will sell it directly to the consumer. In such a situation, the major website is no different than the salesperson with a web site as discussed above, albeit with a larger number of visitors. In another situation, however, the major web site is providing a lead to a salesperson that owns or is affiliated with the asset in return for a referral fee. In such a situation, the major website is capitalizing on its large number of visitors by advertising assets that will actually be sold by a salesperson, in return for receiving a referral fee from the salesperson. In this way, the major web site may earn income in the form of referral fees, without having to expend the energy or resources involved with actually acquiring and/or selling the asset.

The new and secondary automobile industry for cars and parts provides an example. A consumer seeking to purchase a new or used vehicle or part may wish to search the Internet for listings of vehicles or parts having desired features, price and location within a geographic area. A consumer performing such a search typically wants to see all of the vehicles and parts meeting the specified criteria. Again, and as discussed above, such a need for information is well suited to a database-backed web site.

In the automobile example discussed above, an automobile dealership or junkyard web site is likely to have a relatively small volume of visitors. If the expenses of affiliating with a major web site could be tailored to each salesperson's budget, a sales would benefit from the greater public exposure provided by a major web site.

Unfortunately for a salesperson with a limited advertising budget, a major web site usually provides a lead to a salesperson that has agreed to pay the highest referral fee, or for other valuable consideration. Typically, the major web site will agree to provide a lead to a specific salesperson for a set time period. Any consumer who visits the web site and selects an asset that is subject to the agreement will be referred to that salesperson.

A shortcoming of such a scheme is that a salesperson that has limited advertising funds and has been outbid for leads from the major web site will not be able to receive leads from the major web site for the duration of the agreement. As a result, the salesperson has lost an opportunity for receiving leads, and the major web site has lost an opportunity for receiving additional referral fees from the outbid salesperson.

Because of these short comings, some web sites have attempted solutions. Currently there are three major business models for finding used car part through the Internet.

The first example, Carpart.com (www.carpart.com), downloads inventory from its members and posts it online for searching by consumers and other parties. This system does not generate emails to the consumers from individual members, but merely returns a query result from the database on a web page after a consumer enters technical information on the part they are seeking.

The second example, www.unneedapart.com, obtains leads and automatically generates emails to their members. Once a consumer enters their request a message is sent from the system to the consumer informing them that they will be contacted by a member via email. The consumer request is also sent to the member via email who must then have a live sales representative retrieve the email, read the parts request, determine if the item is in stock, the price, and then email a response to the consumer including instructions on how to order.

Presently, when a consumer visits a website such as the two described above, the website requires the consumer to enter their contact information in addition to the part they are seeking. The website then immediately emails this information to their members or subscribers. Members often are charged a monthly fixed fee, but may also be charge on a per lead basis. Additionally, members often have a choice of receiving all leads or having them filtered so only specific leads are received. Upon receipt of an email lead, the member must then send a reply email or call the consumer to inform them if the have the part, pricing, and shipping options. This manual response is time consuming and requires additional human capital over an automated system.

This third model for selling use car parts via lead generation does not utilize an Internet interface, but instead uses a toll free phone number that consumer can call which would enable them to submit a request for a certain part. This process requires much more human interaction, is time consuming, and does not alleviate any of the work load from members.

In view of the foregoing, there is a need for a system and method that overcomes the limitations and drawbacks set forth above. Namely, what is needed is a method and system for assigning linking information to an asset listing or selection criterion on a web site in a manner that enables a plurality of salespeople to be associated with the asset listing or criterion over a given period of time.

The object of the present invention is to reduce the human resources needed to respond to sales leads and reduce the amount of staff necessary to perform the job.

What is also needed is a method and system for dynamically assigning linking information of a plurality of salespeople to such listing or criterion so a plurality of salespeople may receive leads over a given period of time.

Accordingly, the shortcomings associated with the related art have heretofore not been adequately addressed. The present invention addresses such problems by providing a system and processing approach that has not previously been proposed.

### SUMMARY OF THE INVENTION

In accordance with the present a method is disclosed for generating and distributing a sales referral over the Internet for the sale of an asset, which overcomes the aforementioned problems of the prior art. The present invention is a computer program which allows for a large number of member's to upload, download, or store their inventory information for searching by a third party. The present invention generates leads to member's by connecting consumer demands for assets with members who have assets in their inventory and accomplishes this connection through electronic communications sent to the consumer via electronic means such as email, that appear to come from each member individually and personally.

A consumer who engages a website and then enters information relating to the asset they wish to acquire. The consumer's information is then transferred to a central computer that then conducts a search of each member's inventory stored on the central computer for the asset. When the asset is located, the central computer generates an electronic communication that is then sent to the customer including such information as availability and cost.

Member subscribers receive electronic communications every time a consumer inquires about a product that is in their inventory and confirms transmission of an email to the inquiring consumer, from the member. Additionally, member subscribers receive an accounting of requests, transmissions to consumers and other data on a periodic basis as desired.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart depicting a process by which leads are captured, distributed, and answered;

FIG. 2 is a block diagram illustrating an operational environment and various components of a server and consumer access device according to one embodiment of the present invention;

FIG. 3 illustrates the process flow of a consumer interacting with the lead generation system of the present invention and the systematic return of query results.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

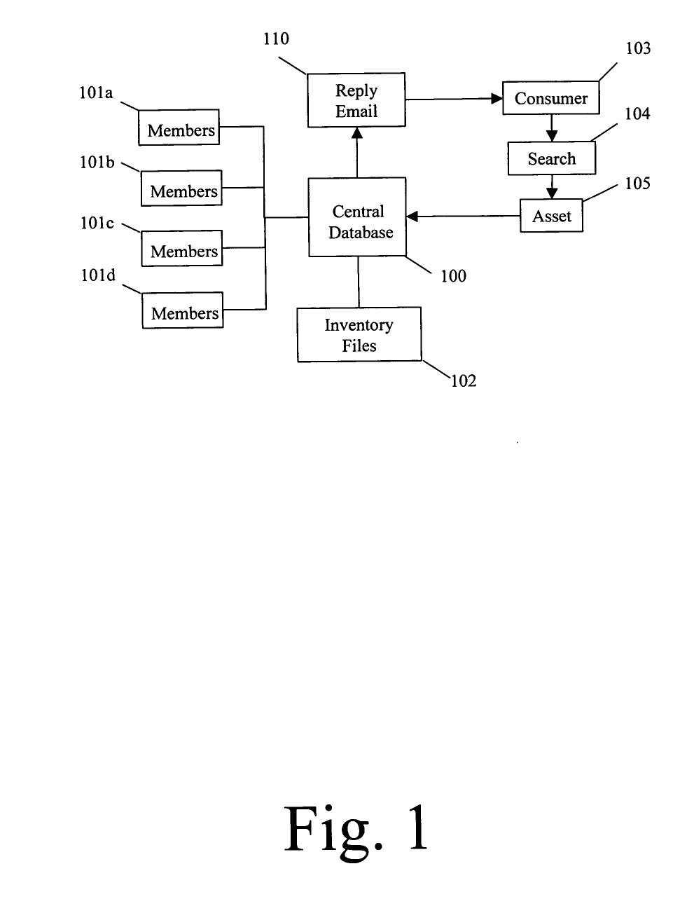

Now referring to FIG. 1, a flow chart depicting a process by which leads are captured, distributed, and answered is shown. A central database 100 is created where a plurality of members 101a-101d can download or retain their inventory files 102. Inventory files 102 can be updated on a periodic basis ranging from hours to weeks. When a consumer 103 places a search 104 for an asset 105, the inventory files 102 located on the central database 100 are searched. Searching is completed by a computer programmed script that compares the search request to all existing databases. The consumer 103 receives an email reply 110 from each member's inventory if there is a match from the consumer's search 104.

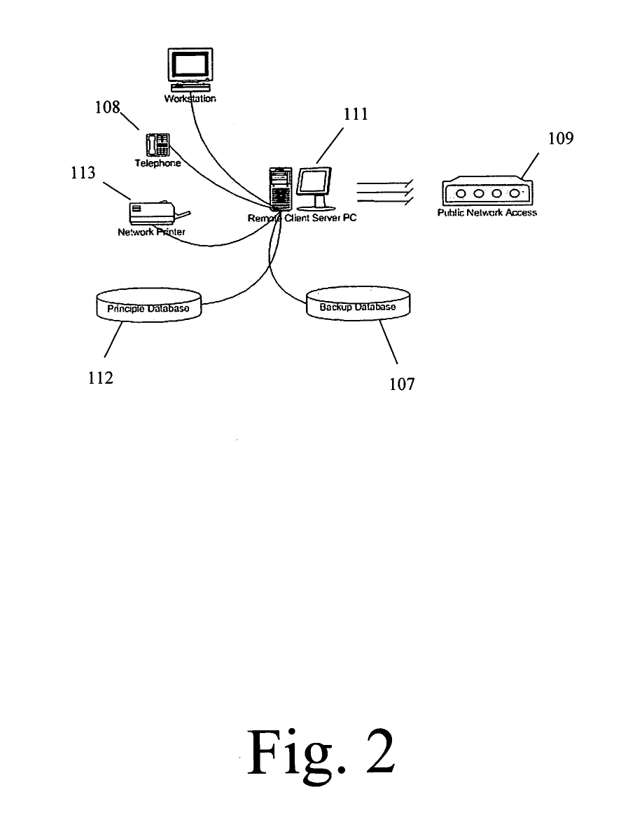

Now referring to FIG. 2, a block diagram illustrating an operational environment and various components of a server and consumer access device according to one embodiment are shown. A host server personal computer 111 contains principle databases 112 and backup databases 107. The principle software components located on the host server personal computer 111 include an operating system, a user client formatted to be compatible with the Hollander automotive parts interchange format, a dialup or network script control, and local databases available on the client server.

The principle database 112 contains the inventory collections of members and, via script functions, is able to parse inventory records to remove duplicates and place quantities in product tables. Additionally, the system can consolidate all member inventories into a global client inventory database that can provide part name lookup forms by location and part name print reports by location on a printer 113.

Inventory database functions require the following functionality. All databases are passive, and wait for network interrogation. Inventory quantities are stored in product tables. Menu driven access prompts remote user interaction. Local administration of lookup forms by part number. Database organization and structure are complimentary to the well-known Hollander parts interchange system.

The host server personal computer 111 is accessible via a standard telephone network 108 and public network access 109 such as the Internet. Additional inventory script functions enable consumers to access the host server personal computer 111 traverse menus to search and print inventory results.

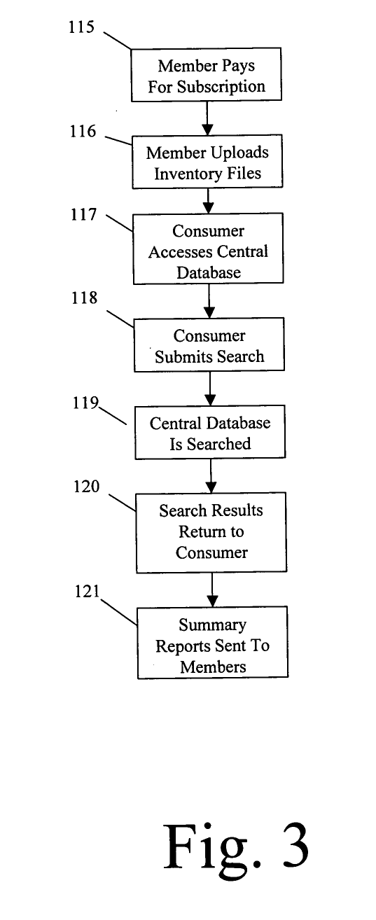

FIG. 3 illustrates the process flow of a consumer interacting with the lead generation system of the present invention and the systematic return of query results. In step 115, a member 101 first pays a subscription fee to the website. In step 116, the member 101 uploads their inventory files 102 to the central database 100. In step 117, a consumer visiting the website enters information to identify themselves and the asset they are seeking.

Information typically necessary for the present invention to function would include, but is not limited to, customer contact information such as name, address, phone number, fax, and email address. Additionally, asset information would be necessary for the computer scripts to properly conduct a search of the central database 100. Asset information for a new or used auto part would typically include the make, model, and year of the car in addition to the part description, i.e. transmission, manifold, wheel, etc.

In step 118, the consumer's search information is submitted and sent to the host server personal computer 105. Upon receipt, the host server personal computer 105 will run a search script 110 in step 119 that will search the central database 100 containing all member inventories for a matching asset.

If an asset is located in the central database 100 as being in one or more member inventories, an email is sent in Step 120 to the consumer informing them that the asset is available and the cost. Additionally, an email is sent to the member informing them that a consumer inquired about a certain asset. It is important to note that in Step 120, and email is generated for each member inventory that contains the asset of the consumer inquiry. For example, if ten member inventories contain the asset of the consumer inquire, the consumer would receive ten emails, one from each member, informing the consumer of the members availability, price, location, and contact information.

In another embodiment, the consumer may elect to limit or filter their search results based on price, location, maximum response amount, or any other number of limiting factors.

In step 121, Members receive periodic accountings with respect to the number of requests were received by the system, the number of leads that were generated and emails sent on their behalf to consumers.

Typical Ascii format is utility to export information for the Central Database to a simple flat file. The flat file contains double parentheses delineation of date field, comma separations fields, and carriage return and line feed per record. Field names include site number, site name, user name (TCP/IP address or telephone number), user password, and an optional capture file name. A sample file would be: “000001”, “TEST,,,SITE”, “bubbaso6.no-ip.com”, “CCF,”“Test_Site.cap” or, “000002”, “Wayne's Hooch”, “test_line”, “wan”, “00002.cap”.

A typical lookup part list is a Microsoft Access data element obtained from a capture Ascii flat file. This file is not routinely updated with imported data. The file is formatted as follows: double parentheses delineation of data field, comma separation of fields, and carriage return and line feed per record. A sample file would be: “00121”, “Fender”, Left Front, Yellow” or “00456”, “Trunk Lid, Slight Dent, Green”.

A typical database inventory record is a Microsoft Access data object obtained from the capture Ascii flat file. The file is formatted as follows: double parentheses delineation of data field, comma separation of fields, and carriage return and line feed per record. Filed names are rigidly formatted by “type” in the database: 1) partno: part number—double integer, 2) year; year of manufacture, 3) model, associated model name, 4) condition, known condition of part, 5) price, current retail price of part, 6) dealer, location code of offering dealer. Parts descriptions are found in a separate lookup table “Part List”. A sample file would be: “00121”, “1978”, “Impala”, “Good”, “$231.00”, “Store #3” or “00456”, “1967”, “Camaro”, “Poor”, “$19.00”, “Store #1”.

It is appreciated that other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A computer implemented system for the creation of lead generations comprising:
a web server;
web portal interface;
multi-user network;
application server;
process scheduler with means to control security and access to said application server;
data repository a company's existing network and infrastructure;
automatically collecting, batching, archiving, analyzing data;
delivering data to a desktop computer;
storing data in a single repository;
performing a comprehensive analysis against specifications supplied by the user;
automatically disseminating results via email,
available process information can be supplemented with other information the user might desire;
a user can export information to other applications, print it out, or email it to interested parties;
analysis and graphing engines process data that can be charted and trended.

2. A method for processing, creating, and responding to sales leads comprising the following steps:
A) a member first pays a subscription fee to join the sales lead service;
B) said member uploads their inventory files to a central database located on a host server;
C) a consumer then visits said website via a multi-user network and enters information to identify themselves and the asset they are seeking;
D) said consumer's information is submitted to the host server wherein the host server runs a search script that searches the central database containing all member inventories for the matching asset;
E) if the asset is located in the central database as being in one or more member inventories, an email is sent to the consumer informing them that the asset is available and the cost; and
F) an email is sent to the member informing them that a consumer inquired about a certain asset.

3. The computer implemented system for the creation of lead generations of claim 1 wherein a typical Ascii format is utility to export information for the central database to a simple flat file, said flat file contains double parentheses delineation of date field, comma separations fields, and carriage return and line feed per record and field names include site number, site name, user name, user password, and an optional capture file name.

4. The computer implemented system for the creation of lead generations of claim 3 wherein a typical lookup part list is comprised of a data element obtained from a capture Ascii flat file, said file is formatted with double parentheses delineation of data field, comma separation of fields, and carriage return and line feed per record and is not routinely updated with imported data.

5. The computer implemented system for the creation of lead generations of claim 3 wherein a typical database inventory record is a data object obtained from the capture Ascii flat file; said file is formatted with double parentheses delineation of data field, comma separation of fields, and carriage return and line feed per record, and field names are rigidly formatted by “type” in the database where:
partno is a part number and is defined by a double integer,
year is the year of manufacture,
model is the associated model name,
condition is the known condition of part,
price is the current retail price of part,
dealer is the location code of offering dealer; and
parts descriptions are found in a separate lookup table.
